(19) United States
(12) Patent Application Publication
(10) Pub. No.: US 2019/0012399 A1
(43) Pub. Date: Jan. 10, 2019

(54) Systems and Methods for Recommending Objects Based on Captured Data

(71) Applicant: Walmart Apollo, LLC, Bentonville, AR (US)

(72) Inventors: Benjamin D. Enssle, Bella Vista, AR (US); Greg A. Bryan, Bentonville, AR (US); Cristy Crane Brooks, Cassville, MO (US); David Blair Brightwell, Bentonville, AR (US); Jesse Lee Eaton, JR., Springdale, AR (US)

(21) Appl. No.: 16/029,920

(22) Filed: Jul. 9, 2018

Related U.S. Application Data
(60) Provisional application No. 62/530,558, filed on Jul. 10, 2017.

(51) Int. Cl. G06F 17/30; G06F 3/12; H04M 1/725

(52) U.S. Cl. CPC G06F 17/30876; G06F 17/30867; G06F 17/30554; G06F 3/1292; G06F 3/1254; H04M 1/7253; H04M 1/72561; G06F 3/1204

(57) ABSTRACT

Described in detail herein are systems and methods for an data interception and transmission system. A wireless access point disposed in a facility can detect a mobile device in the facility executing an facility application associated with the facility. The wireless access point can intercept internet browsing data associated with one or more domains unrelated to a domain associated with the facility within a specified time interval from the mobile device. The computing system can receive the internet browsing data of the at least one mobile device. The computing system can detect information associated with a physical object. The computing system can determine the physical object is disposed in the facility. The computing system can control the operation of the facility application, residing on the mobile device, via the wireless access point to render information associated with the physical object on a display of the mobile device.

### CROSS-REFERENCE TO RELATED PATENT APPLICATIONS

This application claims priority to U.S. Provisional Application No. 62/530,558, filed on Jul. 10, 2017, the content of which is hereby incorporated by reference in its entirety.

### BACKGROUND

It can be a slow and error prone process to determine and detect information associated with physical objects that is extracted from mobile devices.

### BRIEF DESCRIPTION OF DRAWINGS

Illustrative embodiments are shown by way of example in the accompanying drawings and should not be considered as a limitation of the present disclosure. The accompanying figures, which are incorporated in and constitute a part of this specification, illustrate one or more embodiments of the disclosure and, together with the description, help to explain the present disclosure. In the figures:

FIG. 1 is a block diagram of a mobile device that can be utilized to implement and/or interact with embodiments of a system for recommending objects based on captured data;

FIG. 2 illustrates a facility with wireless access points according to an exemplary embodiment;

FIG. 3 illustrates a mobile device within a specified distance of a facility;

FIG. 4 illustrates a network diagram of a system for recommending objects based on captured data in accordance with an exemplary embodiment;

FIG. 5 illustrates a block diagram of an exemplary computing device in accordance with an exemplary embodiment;

FIG. 6 is a flowchart illustrating a process implemented by a system for object recommendation based on captured data according to an exemplary embodiment; and

FIG. 7 is a flowchart illustrating a process implemented by a system for object recommendation based on captured data according to an exemplary embodiment.

### DETAILED DESCRIPTION

Described in detail herein are systems and methods for recommending objects based on captured data. In accordance with embodiments of the present disclosure, wireless access points disposed in a facility can detect mobile devices in the facility that are executing an instance of an application associated with the facility. The wireless access point can intercept internet browsing data associated with one or more domains unrelated to a domain associated with the facility from the mobile devices as when the mobile devices are in the facility. In some embodiments, the system can recommend objects via the application on the mobile devices within a specified time after the wireless access point intercepts the internet browsing data and/or while the mobile devices are detected within the facility. The wireless access point(s) can transmit the internet browsing data to a computing system corresponding to the domain associated with the facility. The computing system can receive the internet browsing data generated by the mobile devices via the wireless access point. The internet browsing data can also be forwarded to the domains identified in the internet browsing data that are unrelated to the domain associated with the facility. The computing system can detect information in the internet browsing data that is associated with physical objects. The computing system can determine whether the physical objects are disposed in the facility, and can control the operation of the application residing on the mobile device, via the wireless access point, to render information associated with the physical objects on a display of the mobile devices.

The computing system can query the database to retrieve additional information for additional physical objects associated with the physical objects, and can control the operation of the application residing on the mobile devices, via the wireless access point, to render the additional information associated with the additional physical objects on the display of the mobile devices. The computing system can determine user information associated with users of the mobile devices and can select the second set of information based on the user information associated with the users of the mobile devices.

In accordance with embodiments of the present disclosure, a mobile device can execute an application and request a physical object, via the application. A computing system can receive the request. The computing system can identify a set of facilities having facility locations within a specified distance of the current geographic location of the mobile device. The computing system can determine user information associated with the user of the application executing the mobile device. The computing system can determine additional physical objects that are associated with the requested physical object and that are disposed at the identified facilities. The computing system can select one of the additional physical objects based on the current geographic location of the mobile device, the user information, and the requested physical object. The computing system can transmit the object information for the selected additional physical object to the application to instruct the application to render object information associated with the selected additional physical object on a display of the mobile device.

The application can receive a second request associated with the at least one of the additional physical objects and transmit the second request to the computing system. A printing device can be operatively coupled to the computing system. The printing device can be disposed in facilities. The computing system is further configured to determine the mobile device is within a specified distance of the facility and control the operation of the printing device to print the at least one of the additional physical objects.

Terminals including a display and an optical scanner can be disposed in the facility and operatively coupled to the computing system. A terminal can be configured to scan a machine-readable element rendered on the display of the mobile device. The machine-readable element is encoded with an identifier associated with the at least one of the additional physical objects. The terminal can transmit the identifier to the computing system. The computing system is programmed to control the operation of the at least one terminal to render the object information associated with the additional physical object on the display in response to receiving the identifier.

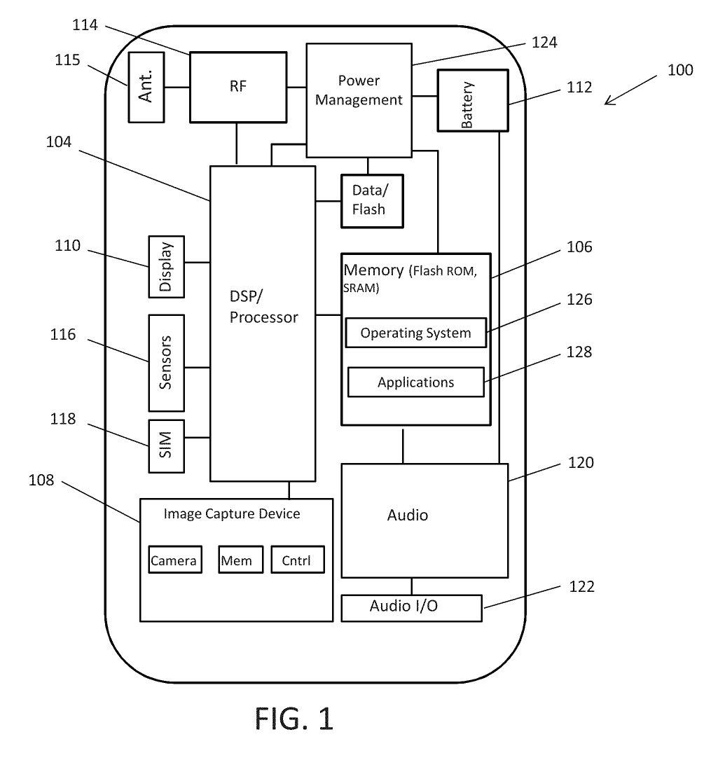

FIG. 1 is a block diagram of a mobile device 100 that can be utilized to implement and/or interact with embodiments of a system for recommending objects based on data interception and transmission. The mobile device 100 can be a smartphone, tablet, subnotebook, laptop, personal digital assistant (PDA), and/or any other suitable mobile device that includes a battery and can be programmed and/or configured to implement and/or interact with embodiments of the system via wireless communication. The mobile device 100 can include a processing device 104, such as a digital signal processor (DSP) or microprocessor, memory/storage 106 in the form a non-transitory computer-readable medium, an image capture device 108, a touch-sensitive display 110, a battery 112, and a radio frequency transceiver 114. Some embodiments of the mobile device 100 can also include other common components commonly, such as sensors 116, subscriber identity module (SIM) card 118, audio input/output components 120 and 122 (including e.g., one or more microphones and one or more speakers), and power management circuitry 124.

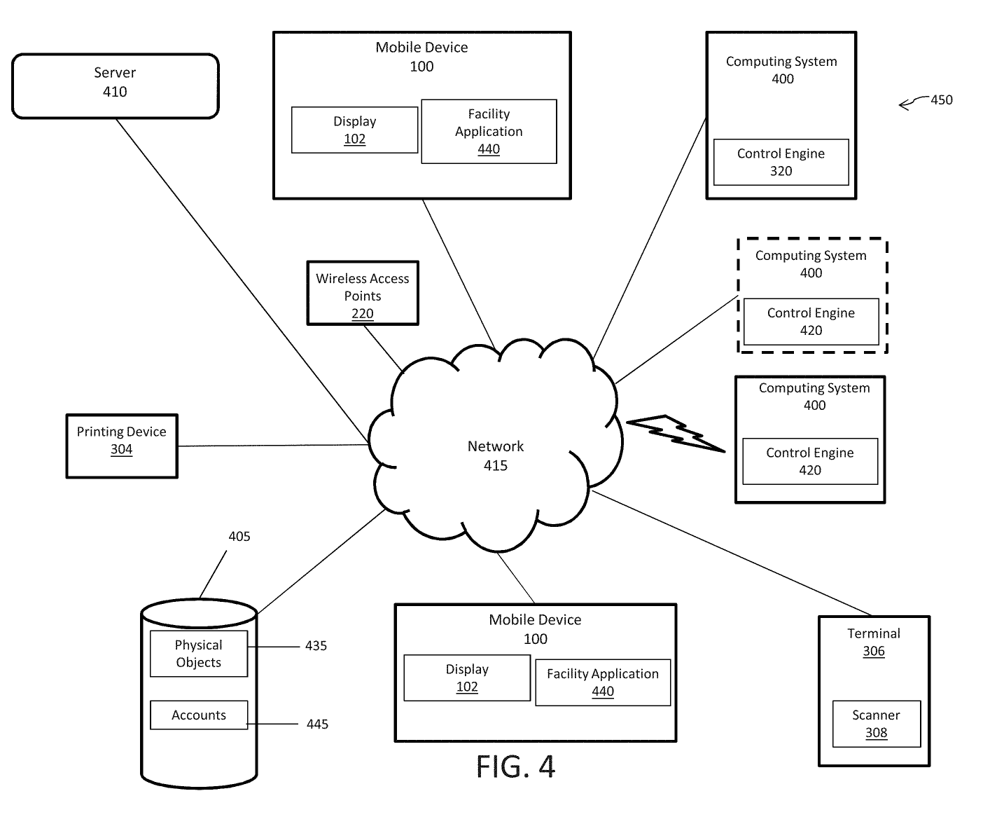

The memory 106 can include any suitable, non-transitory computer-readable storage medium, e.g., read-only memory (ROM), erasable programmable ROM (EPROM), electrically-erasable programmable ROM (EEPROM), flash memory, and the like. In exemplary embodiments, an operating system 126 and applications 128 can be embodied as computer-readable/executable program code stored on the non-transitory computer-readable memory 106 and implemented using any suitable, high or low level computing language and/or platform, such as, e.g., Java, C, C++, C#, assembly code, machine readable language, and the like. In some embodiments, the applications 128 can include an assistance application configured to interact with the microphone, a web browser application, a mobile application specifically coded to interface with one or more servers of embodiments of the system for recommending objects. One or more servers are described in further detail with respect to FIG. 4. While memory is depicted as a single component those skilled in the art will recognize that the memory can be formed from multiple components and that separate non-volatile and volatile memory devices can be used.

The processing device 104 can include any suitable single- or multiple-core microprocessor of any suitable architecture that is capable of implementing and/or facilitating an operation of the mobile device 100. For example, a user can use the mobile device 100 in a facility to perform an image capture operation, capture a voice input of the user (e.g., via the microphone), transmit messages including a captured image and/or a voice input and receive messages from a computing system, display data/information including GUIs of the user interface 110, captured images, voice input transcribed as text, and the like. The mobile device 100 can perform the aforementioned operations using on an internet browser executing on the mobile device, or any web-based application. The processing device 104 can be programmed and/or configured to execute the operating system 126 and applications 128 to implement one or more processes and/or perform one or more operations. The processing device 104 can retrieve information/data from and store information/data to the storage device 106.

The RF transceiver 114 can be configured to transmit and/or receive wireless transmissions via an antenna 115. For example, the RF transceiver 114 can be configured to transmit data/information, such as input based on user interaction with the mobile device 100. The RF transceiver 114 can be configured to transmit and/or receive data/information having at a specified frequency and/or according to a specified sequence and/or packet arrangement.

The touch-sensitive display 110 can render user interfaces, such as graphical user interfaces to a user and in some embodiments can provide a mechanism that allows the user to interact with the GUIs. For example, a user may interact with the mobile device 100 through touch-sensitive display 110, which may be implemented as a liquid crystal touch-screen (or haptic) display, a light emitting diode touch-screen display, and/or any other suitable display device, which may display one or more user interfaces (e.g., GUIs) that may be provided in accordance with exemplary embodiments.

The power source 112 can be implemented as a battery or capacitive elements configured to store an electric charge and power the mobile device 100. In exemplary embodiments, the power source 112 can be a rechargeable power source, such as a battery or one or more capacitive elements configured to be recharged via a connection to an external power supply.

A user can operate the mobile device 100 in a facility, and the graphical user interface can automatically be generated in response executing an application associated with the facility on the mobile device 100. The application can display information associated with physical objects disposed at the facility. A user can use the mobile device 100 to connect with the World Wide Web, e.g., via a web browser application. The mobile device 100 can input and receive data, via the World Wide Web. The data can be stored in a persistent memory of the mobile device, such as ROM as described above. Alternatively, or in addition to the data can be stored in temporary buffers of the mobile device such as SRAM or Flash memory as described above. Wireless access points disposed in facilities can capture the data and transmit the data to a computing system. The wireless access points and computing system are described in further detail with respect to FIG. 4.

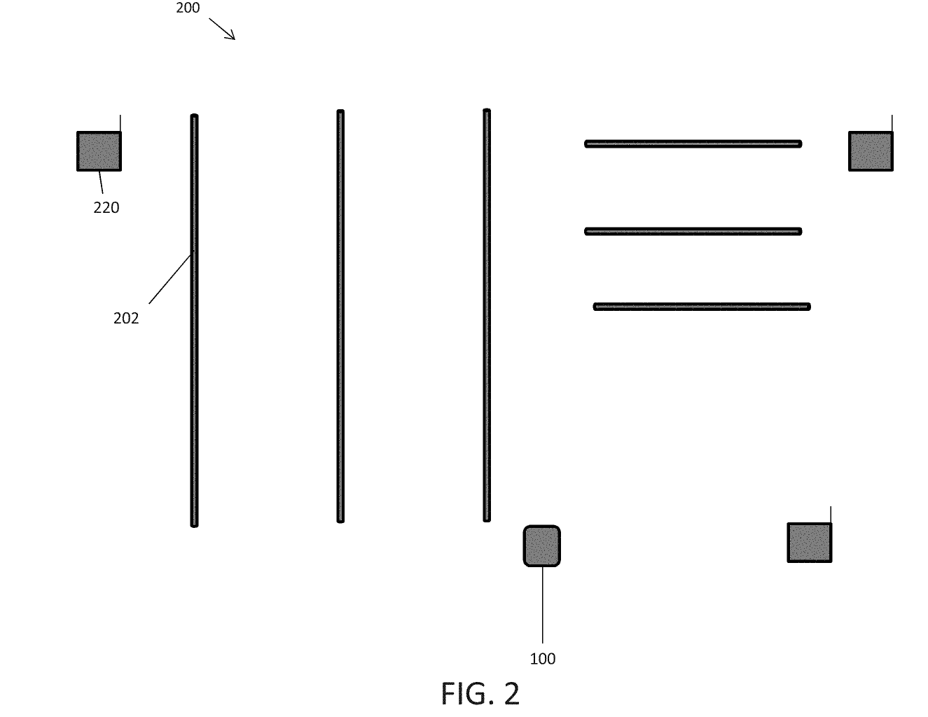

FIG. 2 illustrates a facility with wireless access points 220 according to an exemplary embodiment. As mentioned above, a user can operate a mobile device 100 in a facility 200. Physical objects can be disposed on shelving units 202 throughout the facility 200. The wireless access points 220 can be disposed throughout the facility and can communicate with the mobile devices 100. Wireless access points 220 can include RF transceivers (including transmitters and receivers). The transceivers can be configured to transmit information to mobile devices 100. The receivers can be used to receive information from the mobile devices 100. The wireless access points 220 can communicate with the mobile devices in response to detecting a mobile device 100 within range of the wireless access points 220. More than one wireless access 220 can communicate with the mobile devices.

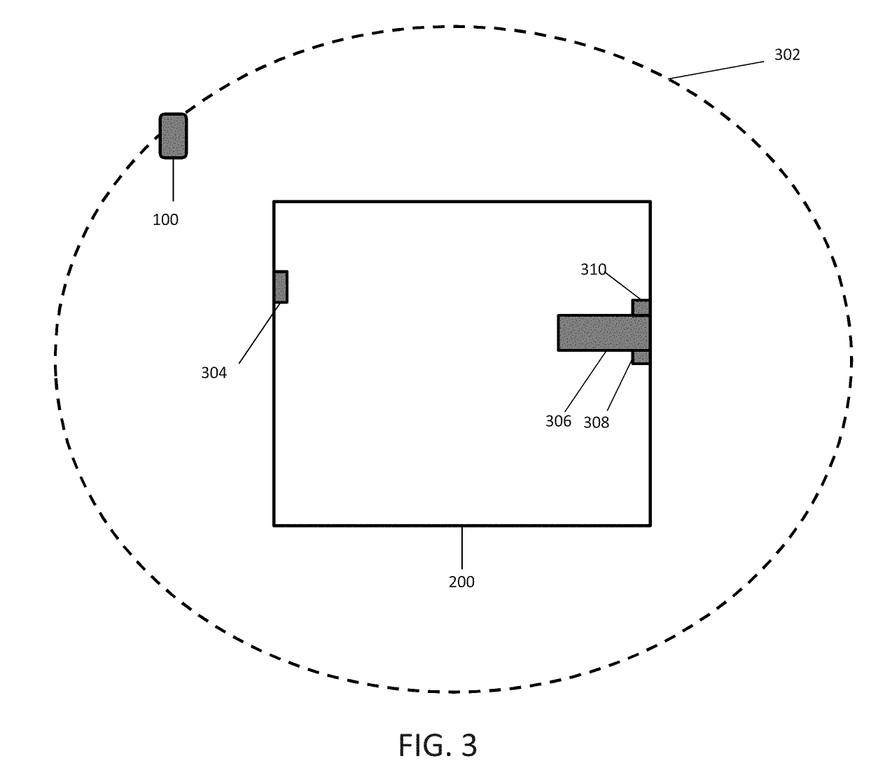

FIG. 3 illustrates a mobile device 100 within a specified distance of a facility 200. As mentioned above, the mobile device 100 can execute an application associated with the facility 200. The computing system can define a geo-fence 302 and can determine that the mobile device has crossed the geo-fence 302 and is within a specified location of the facility 200. A printing device 304 can be disposed within the facility. The printing device 304 can be a laser printer, a photo printer, a 3-D printer or any other type of printing device. The printing device 304 can receive a request to print an object based on a request transmitted from the mobile device 100. The printing device 304 can transmit a confirmation to the computing system, in response to completion of the printing of the object. Terminals 306 can also be disposed in the facility. The terminals 306 can include an optical scanner 308 and display 310. The optical scanner 308 can be configured to scan, read and decode machine-readable elements. An example computing system is described in further detail with respect to FIG. 4.

FIG. 4 illustrates a network diagram in which an embodiment of the system for recommending objects based on data interception and transmission can be implemented in accordance with an exemplary embodiment. The system 450 for recommending objects based on data interception and transmission can include one or more databases 405, one or more computing systems 400, one or more wireless access points 220, one or more printing devices 304, one or more terminals 306 and one or more mobile devices 100, communicating over communication network 415. The terminals 306 can include an optical scanner 308 and a display 310. The printing device 304 can be a laser printer, a 3D-printer, a photo printer or any other type of printing device. The wireless access points 220 can be disposed throughout the facility. The mobile device 100 can include a display 110 and can execute a facility application 440. The facility application 440 can be an executable application residing on the mobile device 100, as described herein. The computing system 400 can execute one or more instances of a control engine 420. The control engine 420 can be an executable application residing on the computing system 400 to implement the system 450 as described herein.

In an example embodiment, one or more portions of the communications network 415 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The computing system 400 includes one or more computers or processors configured to communicate with the databases 405, wireless access points 220, and mobile devices 100 via the network 415. The computing system 400 hosts one or more applications configured to interact with one or more components of the system 450. The databases 405 may store information/data, as described herein. For example, the databases 405 can include a physical objects database 430 and an accounts database 445. The physical objects database 430 can store information associated with physical objects. The accounts database 445 can include information about accounts associated with the facility application 440. The databases 405 can be located at one or more geographically distributed locations from the first computing system 400. Alternatively, the databases 405 can be included within the computing system 400.

In one embodiment, a user of a mobile device 100 can request to execute the facility application 440 while in a facility. Using the application, the user can select to receive updates regarding physical objects disposed in the facility based on their internet browsing data The computing system 400 can execute the control engine 420 in response to receiving the request. The request can include the location of the mobile device 100 and a device identifier. The mobile device 100 identifier can be one or more of Unique Device ID (UDID), the International Mobile Equipment Identity (IMEI), Integrated Circuit Card Identifier (ICCID) and/or the Mobile Equipment Identifier (MEID). The control engine 420 can determine the location of the mobile device 100 is within the facility. The control engine 420 can retrieve an account associated with the mobile device 100 from the accounts database 445, using the device identifier. The control engine 420 can initiate a session associated with the mobile device 100 in the accounts database 435, indicating the mobile device 100 is within a facility and has launched the facility application 440. The control engine 420 can instruct the wireless access points 220 disposed throughout the facility to detect internet traffic from the mobile device 100, while the mobile device 100 is within the facility and the mobile device 100 is executing the facility application 440.

The wireless access points 220 can detect the mobile device 100 in the facility. Each wireless access point 220 can detect the mobile device 100 based on its proximity to the wireless access point 100. The wireless access points 220 can detect the internet traffic of the mobile device 100, while in the facility and the executing the facility application 440. The internet traffic can include internet browser activity, search engine activity, internet browser history and cache and the use of other applications. The wireless access points 220 can capture the internet traffic from the mobile device and determine any data in the internet traffic associated with physical objects disposed in the facility, acquired from domains other than the domain associated with the facility application 440. In some embodiments, the wireless access points 220 can execute a meta-search engine, to detect the data from the internet traffic. The wireless access points 220 can transmit the data to the computing system 400 and can forward the internet traffic to the intended domain.

The control engine 420 can identify the physical objects information from the data. The control engine 420 can query the physical objects database 435 and the accounts database 440, based on the identified physical objects information. For example, the control engine 435 can identify a first physical object from the data, and query the physical objects database 435 to determine information associated with the first physical object. The information can include, name, type, size, amount of the first physical object disposed in the facility and other information associated with the first physical object. The control engine 420 can also query the physical objects database 435 to retrieve information associated with physical objects associated or similar to the first physical object. The control engine 420 can also query the accounts database 445 to determine the user's preferences associated with the first physical object. The control engine 420 an generate an alert associated with the first physical object and instruct the wireless access points 220 to transmit the alert to the mobile device. The wireless access points 220 can transmit the alert to the mobile device 100. The alert can be displayed via, the facility application 440. In some embodiments, the facility application 440 can be automatically displayed on the display 110 in response to receiving the alert.

In some embodiments, the computing system 400 can receive a request for a physical object, via the facility application 440 executed on the mobile device 100, while the mobile device 100 is not in a facility. The request can include the location of the mobile device 100 and the device identifier. The control engine 420 can retrieve an account for the mobile device 100 from the accounts database 445 using the device identifier. The control engine 420 can also determine the mobile device is within a specified distance of a facility in which a printing device 304 is disposed. The control engine 420 can query the physical objects database 435 to retrieve information associated with a physical object disposed in the facility and associated with the requested physical object. The control engine 420 can query the accounts database to retrieve information associated with a user of the mobile device 100. The control engine 420 can generate an alert including information associated with the physical object disposed in the facility. The control engine 420 can transmit the alert to the mobile device 100, to be displayed on the display 110, via the facility application 440.

The control engine 420 can receive another request in response to the transmitted alert. The request can be for the physical object disposed in the facility, which was included in the alert. The control engine 420 can instruct the printing device 304 to print and/or fabricate the requested physical object in response to receiving the request. The control engine 420 can transmit an alert to the mobile device 100 on completion of the printing and/or fabrication of the requested physical object. The alert can include a machine-readable element encoded with an identifier associated with the requested physical object.

The user can retrieve the requested physical object from the facility. The user can present the machine-readable element on the display 110 of the mobile device 100, at a terminal 306. An optical scanner 308 can scan and decode the identifier from the machine-readable element. The optical scanner 308 can transmit the identifier to the computing system 400. The control engine 420 can query the physical objects database 435 to retrieve information associated with the requested physical object, in response to receiving the identifier. The control engine 420 can display the information on the display 310 of the terminal 304. The requested physical object can be retrieved for the user.

As a non-limiting example, the system 450 can be implemented in a retail store and/or e-commerce environment. A user of a mobile device 100 can request to execute the facility application 440 while in a retail store. Using the application, the user can select to receive updates regarding products in the store based on their internet browsing data. The computing system 400 can execute the control engine 420 in response to receiving the request. The request can include the location of the mobile device 100 and a device identifier. The control engine 420 can initiate a session associated with the mobile device 100 in the accounts database 435, indicating the mobile device 100 is within a retail store and has launched the facility application 440. The control engine 420 can instruct the wireless access points 220 disposed throughout the retail store to detect internet traffic from the mobile device 100, while the mobile device 100 is within the retail store and the mobile device 100 is executing the facility application 440.

The wireless access points 220 can detect the mobile device 100 in the retail store. The wireless access points 220 can detect the internet traffic of the mobile device 100, while in the facility and the executing the facility application 440. The wireless access points 220 can capture the internet traffic from the mobile device and determine any data in the internet traffic associated with products disposed in the facility, acquired from domains other than the domain associated with the facility application 440. For example, the data can include internet browsing data of laptops which are sold in the facility. In some embodiments, the wireless access points 220 can execute a web-crawler, to detect the data from the internet traffic. The wireless access points 220 can transmit the data to the computing system 400.

The control engine 420 can identify the products information from the data. The control engine 420 can query the physical objects database 435 and the accounts database 440, based on the identified products information. For example, the control engine 435 can identify a laptop sold at the facility from the data, and query the physical objects database 435 to determine information associated with the laptop. The information can include, name, type, size, price, sales history, amount of the particular laptops disposed in the facility and other information associated with the first product. The control engine 420 can also query the physical objects database 435 to retrieve information associated with products associated or similar to the first product (i.e. similar laptops of different brands or types). The control engine 420 can also query the accounts database 445 to determine the user's preferences associated with the laptop. The control engine 420 can generate an alert associated with the laptop and instruct the wireless access points 220 to transmit the alert to the mobile device. As an example, the alert can include a sale on the specified laptop or similar laptops. The wireless access points 220 can transmit the alert to the mobile device 100. The alert can be displayed via, the facility application 440. In some embodiments, the facility application 440 can be automatically displayed on the display 110 in response to receiving the alert.

As another non-limiting example, in some embodiments, the computing system 400 can receive a sale of a product, via the facility application 440 executed on the mobile device 100, while the mobile device 100 is not in a retail store. The control engine 420 can retrieve an account for the mobile device 100 from the accounts database 445 using the device identifier. The control engine 420 can also determine the mobile device is within a specified distance of a retail store in which a printing device 304 is disposed. The control engine 420 can query the products database 435 to retrieve information associated with a product disposed in the facility and associated with the requested product. The control engine 420 can query the accounts database to retrieve information associated with a user of the mobile device 100. For example, the control engine 420 can determine the user is interested in free photo prints. The control engine 420 can generate an alert including information associated with the product disposed in the facility. The control engine 420 can transmit the alert to the mobile device 100, to be displayed on the display 110, via the retail store application 440.

The control engine 420 can receive another request in response to the transmitted alert. The request can be for the product disposed in the retail store, which was included in the alert. The control engine 420 can instruct the printing device 304 to print and/or fabricate the requested product in response to receiving the request (i.e. free photo-prints). The control engine 420 can transmit an alert to the mobile device 100 on completion of the printing and/or fabrication of the requested product. The alert can include a machine-readable element encoded with an identifier associated with the requested product.

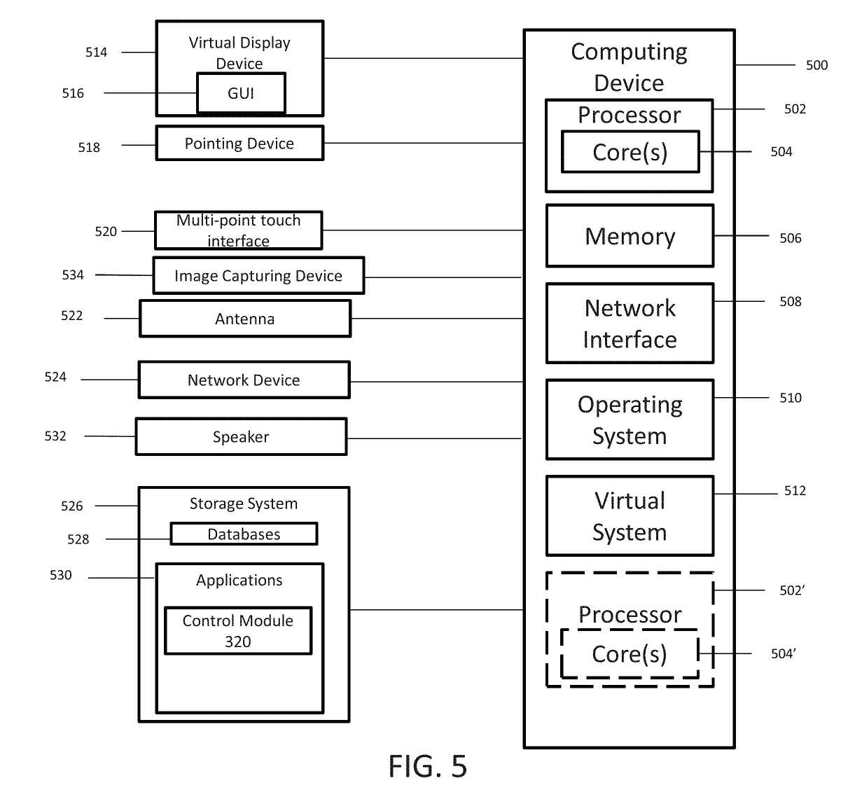

FIG. 5 is a block diagram of an exemplary computing device suitable for implementing embodiments of the data interception and transmission system. The computing device may be, but is not limited to, a smartphone, laptop, tablet, desktop computer, server or network appliance. The computing device 500 can be embodied as the computing system and/or mobile device. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 506 included in the computing device 500 may store computer-readable and computer-executable instructions or software (e.g., applications 530 such as the control engine 420 and/or the facility application 440) for implementing exemplary operations of the computing device 500. The computing device 500 also includes configurable and/or programmable processor 502 and associated core(s) 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for implementing exemplary embodiments of the present disclosure. Processor 502 and processor(s) 502′ may each be a single core processor or multiple core (504 and 504′) processor. Either or both of processor 502 and processor(s) 502′ may be configured to execute one or more of the instructions described in connection with computing device 500.

Virtualization may be employed in the computing device 500 so that infrastructure and resources in the computing device 500 may be shared dynamically. A virtual machine 512 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof. The computing device 500 can receive data from input/output devices such as, a reader 534 and an image capturing device 532.

A user may interact with the computing device 500 through a visual display device 514, such as a computer monitor, which may display one or more graphical user interfaces 516, multi touch interface 520 and a pointing device 518.

The computing device 500 may also include one or more storage devices 526, such as a hard-drive, CD-ROM, or other computer readable media, for storing data and computer-readable instructions and/or software that implement exemplary embodiments of the present disclosure (e.g., applications such as the control engine 420 and/or the facility application 440). For example, exemplary storage device 526 can include one or more databases 528 for storing information regarding the physical objects and accounts. The databases 528 may be updated manually or automatically at any suitable time to add, delete, and/or update one or more data items in the databases.

The computing device 500 can include a network interface 508 configured to interface via one or more network devices 524 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing system can include one or more antennas 522 to facilitate wireless communication (e.g., via the network interface) between the computing device 500 and a network and/or between the computing device 500 and other computing devices. The network interface 508 may include a built-in network adapter, network interface card, PCMCIA network card, card bus network adapter, wireless network adapter, USB network adapter, modem or any other device suitable for interfacing the computing device 500 to any type of network capable of communication and performing the operations described herein.

The computing device 500 may run any operating system 510, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 500 and performing the operations described herein. In exemplary embodiments, the operating system 510 may be run in native mode or emulated mode. In an exemplary embodiment, the operating system 510 may be run on one or more cloud machine instances.

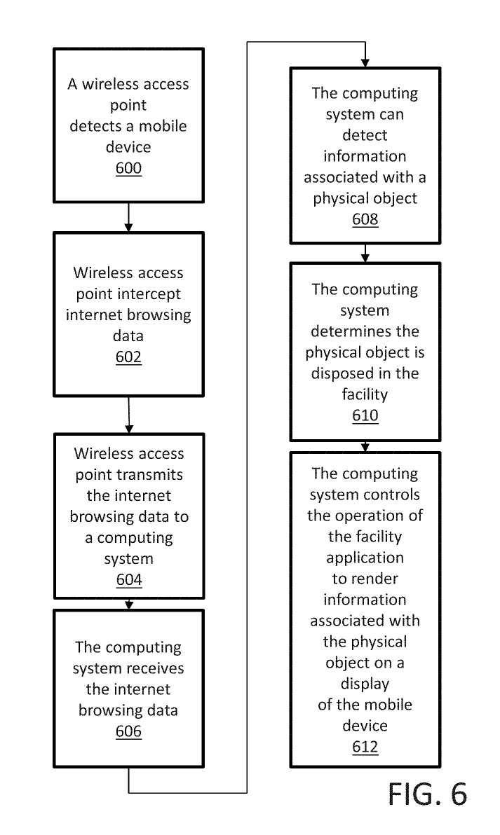

FIG. 6 is a flowchart illustrating an example process implemented by an embodiment of the system for recommending objects based on data interception and transmission according to an exemplary embodiment. In operation 600, a wireless access point (e.g. wireless access point 220 as shown in FIGS. 2 and 4), disposed in a facility 200 can detect a mobile device (e.g. mobile device 100 as shown in FIG. 1) in the facility executing an facility application (e.g. facility application 440 as shown in FIG. 4) associated with the facility. In operation 602, the wireless access point can intercept internet browsing data associated with one or more domains unrelated to a domain associated with the facility within a specified time interval from the mobile device. In operation 604, the wireless access point can transmit the internet browsing data to a computing system corresponding to the domain associated with the facility (e.g. computing system 400 as shown in FIG. 4) and can forward the internet browsing data to the intended domain. In operation 606, the computing system can receive the internet browsing data of the mobile device from the wireless access point. In operation 608, the computing system can detect information associated with a physical object. In operation 610, the computing system can determine the physical object is disposed in the facility. In operation 612, the computing system can control the operation of the facility application, residing on the mobile device, via the wireless access point to render information associated with the physical object on a display (e.g. display 110 as shown in FIGS. 1 and 4) of the mobile device.

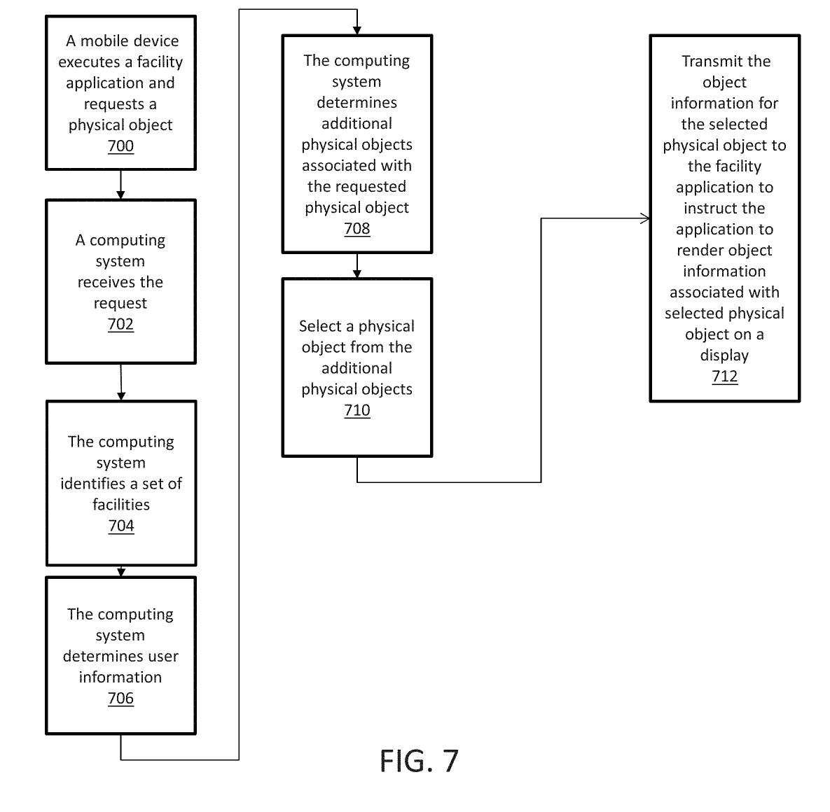

FIG. 7 is a flowchart illustrating an example process implemented by an embodiment of the system for recommending objects based on data interception and transmission according to an exemplary embodiment. In operation 700, a mobile device (e.g. mobile device 100 as shown in FIGS. 1 and 4) can execute a facility application (e.g. facility application 440 as shown in FIG. 4) and request a physical object, via the facility application. In operation 702, a computing system (e.g. computing system 400 as shown in FIG. 4) can receive the request. In operation 704, the computing system can identify a set of facilities having facility locations within a specified distance of the current geographic location of the mobile device. In operation 706, the computing system can determine user information associated with the user of the facility application executed by the mobile device. In operation 708, the computing system can determine additional physical objects associated with the requested physical object and disposed at the facilities. In operation 710, the computing system can select a physical object from the additional physical objects disposed at a facility from the facilities based on the current geographic location of the mobile device, the user information, and the requested physical object. In operation 712, the computing system can transmit the object information for the selected physical object to the facility application to instruct the application to render object information associated with selected physical object on a display (e.g. display 110 as shown in FIGS. 1 and 4) of the mobile device.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A system for recommending objects based on intercepted browsing data, the system comprising:
a wireless access point disposed in a facility, the wireless access point configured to:
detect at least one mobile device in the facility executing an application associated with the facility;
intercept internet browsing data associated with one or more domains unrelated to a domain associated with the facility within a specified time interval from the at least one mobile device; and
transmit the internet browsing data;
a computing system corresponding to the domain associated with the facility, the computing system being operatively coupled to the wireless access point, the computing system programmed to:
receive the internet browsing data of the at least one mobile device from the wireless access point;
detect a first set of information associated with at least one physical object in the internet browsing data;
determine the at least one physical object is disposed in the facility;
control the operation of the application, residing on the at least one mobile device, via the wireless access point to render a second set of information associated with the physical object on a display of the at least one mobile device.

2. The system of claim 1, wherein the internet browsing data includes one or more of: browsing history, cookies and internet cache.

3. The system of claim 1, wherein the second set of information is associated with the facility.

4. The system of claim 1, wherein the computing system is programmed to:
query the database to retrieve additional information for additional physical objects associated with the at least one physical object; and
control the operation of the application, residing on the at least one mobile device, via the wireless access point to render the additional information associated with the additional physical objects on the display of the at least one mobile device.

5. The system of claim 1, wherein the computing system is programmed to:
determine user information associated with a user of the at least one mobile device; and
determine the second set of information based on the user information associated with the user of the at least one mobile device.

6. The system of claim 1, wherein the first set of information includes one or more of: an identifier associate with the at least one physical object, an image of the at least one physical object, and a description of the at least one physical object.

7. A physical object retrieval notification system, the system comprising:
an application associated with a user, executing on at least one mobile device, the application configured to transmit a first request for at least one physical object over a communication network, the first request including a current geographic location of the at least one mobile device;
a computing system programmed to:
receive the first request via the communication network;
identify a set of facilities having facility locations within a specified distance of the current geographic location of the mobile device;
determine user information associated with the user of the application executing on the at least one mobile device;
determine additional physical objects associated with the at least one physical object and disposed at the facilities;
select at least one of the additional physical objects disposed at a first one of the facilities based on the current geographic location of the mobile device, the user information, and the at least one physical object; and
transmit the object information for the at least one of the additional physical objects to the application to instruct the application to render object information associated with the at least one of the additional physical objects on a display of the at least one mobile device.

8. The system of claim 7, wherein the application is configured to:
receive a second request associated with the at least one of the additional physical objects; and
transmit the second request to the computing system.

9. The system of claim 8, further comprising:
a printing device operatively coupled to the computing system, the printing device disposed in the first one of the facilities.

10. The system of claim 9, wherein the computing system is configured to:
determine the at least one mobile device is within a specified distance of the facility; and
control the operation of the printing device to print the at least one of the additional physical objects.

11. The system of claim 7, further comprising:
a plurality of terminals including a display and an optical scanner, disposed in the facility and operatively coupled to the computing system, at least one terminal configured to:
scan a machine-readable element rendered on the display of the at least one mobile device, the machine-readable element being encoded with an identifier associated with the at least one of the additional physical objects; and
transmit the identifier to the computing system.

12. The system of claim 11, wherein the computing system is programmed to:
control the operation of the at least one terminal to render the object information associated with the at least one of the additional physical objects on the display in response to receiving the identifier.

13. The system of claim 7, wherein the computing system is programmed to:
determine a quantity of the at least one of the additional physical objects disposed at the first one of the facilities, is more than a threshold amount.

14. A method comprising:
detecting, via a wireless access point disposed in a facility, at least one mobile device in the facility executing an application associated with the facility;
intercepting, via the wireless access point, internet browsing data associated with one or more domains unrelated to a domain associated with the facility within a specified time interval from the at least one mobile device;
transmitting, via the wireless access point, the internet browsing data;
receiving, via a computing system corresponding to the domain associated with the facility, the computing system being operatively coupled to the wireless access point, the internet browsing data of the at least one mobile device from the wireless access point;
detecting, via the computing system, a first set of information associated with at least one physical object in the internet browsing data;
determining, via the computing system, the at least one physical object is disposed in the facility;
controlling, via the computing system, the operation of the application, residing on the at least one mobile device, via the wireless access point to render a second set of information associated with the physical object on a display of the at least one mobile device.

15. The method of claim 14, wherein the internet browsing data includes one or more of: browsing history, cookies and internet cache.

16. The method of claim 14, wherein the second set of information is associated with the facility.

17. The method of claim 14, further comprising:
querying, via the computing system, the database to retrieve additional information for additional physical objects associated with the at least one physical object; and
controlling, via the computing system, the operation of the application, residing on the at least one mobile device, via the wireless access point to render the additional information associated with the additional physical objects on the display of the at least one mobile device.

18. The method of claim 14, further comprising:
determining, via the computing system, user information associated with a user of the at least one mobile device; and
determining, via the computing system, the second set of information based on the user information associated with the user of the at least one mobile device.

19. The method of claim 14, wherein the first set of information includes one or more of: an identifier associate with the at least one physical object, an image of the at least one physical object, and a description of the at least one physical object.
